(19) United States
(12) Patent Application Publication
(10) Pub. No.: US 2005/0156948 A1
(43) Pub. Date: Jul. 21, 2005

(54) Electronic device including a display

(76) Inventor: Bernard Hunt, Redhill (GB)

Correspondence Address: PHILIPS INTELLECTUAL PROPERTY & STANDARDS, P.O. BOX 3001, BRIARCLIFF MANOR, NY, 10510, US

(21) Appl. No.: 10/511,800

(22) PCT Filed: Apr. 3, 2003
(86) PCT No.: PCT/IB03/01351

(30) Foreign Application Priority Data
Apr. 23, 2002 (GB) 0209219.5

(51) Int. Cl. G09G 5/00

(52) U.S. Cl. 345/648

(57) ABSTRACT

A device with a display is operable in at least two modes, a first mode in which display data is provided to the screen for viewing in a first orientation and a second mode in which display data is provided to the screen for viewing in a second, orthogonal, orientation. In the first mode, the display data fills the screen, and in the second mode the display data comprises two images for filling the screen. The aspect ratio for at least one of the two images in the second mode can then be the same as for the image in the first mode.

This invention relates to electronic devices including a display, particularly but not exclusively portable devices.

Devices frequently termed “web pads” or multimedia tablets” are becoming popular, which comprise a hand held portable device with a display to output and some form of input interface. The display screen typically has a touch sensitive input, which may be the main user input to the device, although other inputs may be provided such as some keys and a joystick. These devices are used for web browsing or viewing video material, or indeed combinations of these.

These devices are typically relatively small, for example at most A4 size, and are hand held. It has been proposed to enable the display to be driven either in a landscape or a portrait mode, and the physical orientation of the device is simply adapted to the desired mode.

It is increasingly common to use split screen configurations to view different information sources simultaneously, for example video data, web data or teletext information. A problem with the partition of a screen to display multiple data sources is that the aspect ratio for video data, at least, should be kept constant. If a video output is reduced in size to provide space for the display of other data, the partitioning of the screen results in an irregular shape for the other data. As a result, some display area is either wasted, or else the aspect ratio of the video data is altered which distorts the video image.

According to the invention, there is provided an electronic device including an electronic display comprising a screen and circuitry for providing display data to the screen, wherein the circuitry is operable in at least two modes, a first mode in which display data is provided to the screen for viewing in a first orientation and a second mode in which display data is provided to the screen for viewing in a second, orthogonal, orientation, and wherein in the first mode the display data comprises a first image for display substantially filling the screen, and in the second mode the display data comprises second and third images for occupying different areas of the screen.

This device enables a single image to fill the screen in one orientation, and if two (or more) images are to be viewed simultaneously, a perpendicular orientation can be used. This enables the aspect ratio for at least one of the second and third images to be the same as for the first image, whilst still filling the width of the screen. Thus, the second and third images may each occupy a rectangle, with one rectangle having the same aspect ratio as the screen, and with the second and third rectangles together substantially filling the screen.

The screen may have an aspect ratio of 16:9, for standard video data. In the first mode, a video image will fill the screen. In the second mode, the video image is reduced to 9/16 of its linear dimensions, and the resulting image then fills the width of the screen (which is the shorter side in the second orientation).

Alternatively, the screen may have an aspect ratio of approximately √2:1. In this case, the rotation of the screen can result in two sub-screens of identical aspect ratio.

The second and third images are preferably provided one above the other and occupy substantially the full width of the screen in the second orientation.

The display screen may be rotatable with respect to the device between the first and second orientations. This enables the orientation of other input devices, such as keys, to be kept constant. This will be appropriate if the device includes a keyboard. However, this may not be required, and it may be appropriate simply to rotate the entire device, for example if the main input is a touch-sensitive screen.

The input devices may be detachable from the part of the device carrying the screen, for example a remote joystick, keyboard, mouse etc.

The invention also provides a method of displaying data on a screen comprising:
determining whether to display according to a first or second mode of operation;
when displaying in the first mode of operation, providing display data comprising an image to substantially fill the screen in a first orientation, and
when displaying in the second mode of operation, providing display data comprising second and third images for occupying different areas of the screen in a second, orthogonal, orientation.

The step of determining whether to display according to a first or second mode of operation may be carried out automatically in dependence on the display data, or in response to an instruction from a user of the device.

Examples of the invention will now be described in detail with reference to the accompanying drawings, in which:

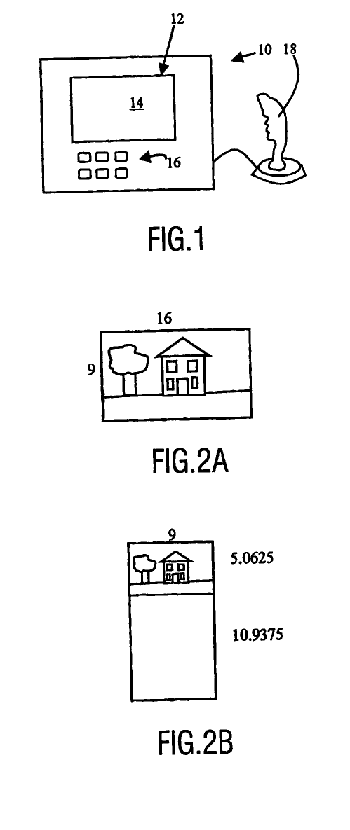

FIG. 1 shows a device according to the invention;

FIG. 2 shows the two screen orientations of the device of FIG. 1, for a first screen aspect ratio;

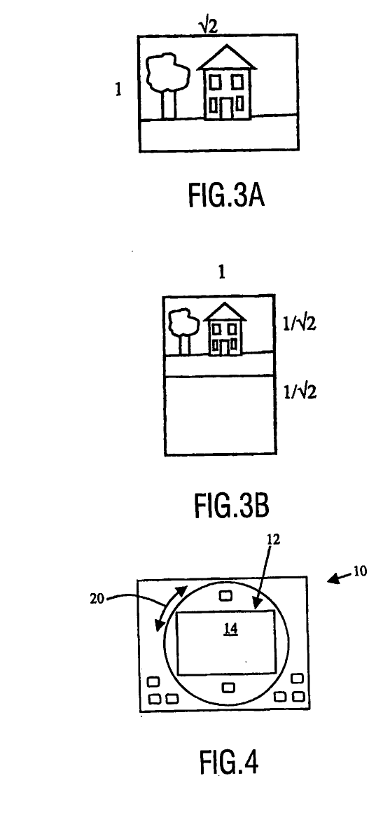

FIG. 3 shows the two screen orientations of the device of FIG. 1, for a second screen aspect ratio; and

FIG. 4 shows a second example of device according to the invention.

FIG. 1 shows an electronic device 10 of the invention. The device is a portable device, for example for viewing web and video data. The device 10 includes a display 12, for example a liquid crystal display, having a screen 14. Internally, conventional circuitry is provided for driving the display.

The screen 14 has a touch sensitive input surface, and this may avoid the need for other manual input interfaces, although by way of example, some key inputs 16 and a remote joystick 18 are shown. There are many other possible input devices, such as a mouse pad for moving a cursor around the screen and a numeric or even a full keyboard.

In accordance with the invention, the display can be driven in at least two modes, a first mode in which display data is provided to the screen for viewing in a first orientation and a second mode in which display data is provided to the screen for viewing in a second, orthogonal, orientation. In particular, in the first mode a first image for display substantially fills the screen, whereas in the second mode, two separate images occupy different areas of the screen.

FIG. 2 shows the display in the two orthogonal orientations when the screen has an aspect ratio of 16:9, which makes the screen suitable for widescreen video format.

In the normal landscape orientation, a video image can fill the screen as shown in FIG. 2A. In the second portrait orientation shown in FIG. 2B, two images are viewed simultaneously. The aspect ratio for the top of the two images in FIG. 2B is the same (i.e. 16:9), with linear dimensions reduced to 9/16, and the image fills the width of the screen. This leaves a rectangle for the image below, which may for example be used for web browser data associated with the video (or live TV) broadcast. As shown in FIG. 2B, the aspect ratio for the remaining portion of the screen is 9:10.9375.

As shown in FIG. 3, the screen may have an aspect ratio of √2:1. In this case, the rotation of the screen can result in two sub-screens of identical aspect ratio (because √2:1=1:√2/2). This aspect ratio also enables four sub-screens of identical aspect ratio to fill the screen in the landscape orientation.

Typically, the complete device will be rotated to enable viewing in the selected orientation. The input devices may be detachable from the part of the device carrying the screen, for example a remote joystick, keyboard, mouse etc, so that they can maintain their required orientation when the screen part of the device is rotated.

Alternatively, and as shown in FIG. 4, the display screen may be rotatable with respect to the device between the first and second orientations, as shown by arrow 20. This enables the orientation of other input devices, such as keys, to be kept constant. This may be appropriate, for example, if the device includes an intergrated keyboard.

In order to switch between display modes, the user may make an appropriate input. Alternatively, this may be automatic in dependence on the display data. If the display is physically rotatable (as in FIG. 4), the orientation can be sensed, and the display driven appropriately.

The ability to drive the display in two modes will require adaptation to the operation of a conventional display. Preferably, the adaptation is purely in software, so that no adaptation of the row and column driver circuits is required. Devices are known with the ability to drive the display in landscape or portrait mode, and the specific implementation of the invention will be routine to those skilled in the art.

Other modifications will be apparent to those skilled in the art.

1. An electronic device including an electronic display comprising a screen and circuitry for providing display data to the screen, wherein the circuitry is operable in at least two modes, a first mode in which display data is provided to the screen for viewing in a first orientation and a second mode in which display data is provided to the screen for viewing in a second, orthogonal, orientation, and wherein in the first mode the display data comprises a first image for display substantially filling the screen, and in the second mode the display data comprises second and third images for occupying different areas of the screen.

2. A device as claimed in claim 1, wherein the screen has an aspect ratio of approximately 16:9.

3. A device as claimed in claim 1, wherein the screen has an aspect ratio of approximately 1.4:1.

4. A device as claimed in any preceding claim, wherein the second and third images are provided one above the other and occupy substantially the full width of the screen in the second orientation.

5. A device as claimed in any preceding claim, wherein the display screen is rotatable with respect to the device between the first and second orientations.

6. A method of displaying data on a screen comprising:
determining whether to display according to a first or second mode of operation;
when displaying in the first mode of operation, providing display data comprising an image to substantially fill the screen in a first orientation, and
when displaying in the second mode of operation, providing display data comprising second and third images for occupying different areas of the screen in a second, orthogonal, orientation.

7. A method as claimed in claim 6, wherein the second and third images are provided one above the other and occupy substantially the full width of the screen in the second orientation.

8. A method as claimed in claim 6 or 7, wherein the step of determining whether to display according to a first or second mode of operation is carried out automatically in dependence on the display data.

9. A method as claimed in claim 6 or 7, wherein the step of determining whether to display according to a first or second mode of operation comprises receiving an instruction from a user of the device.
